(19) United States
(12) Patent Application Publication
(10) Pub. No.: US 2007/0298784 A1
(43) Pub. Date: Dec. 27, 2007

(54) Information processing device

(75) Inventors: Minoru Yamashita, Tokyo (JP); Takato Yokouchi, Tokyo (JP); Tadatsugu Kotani, Tokyo (JP); Kazuo Maehara, Tokyo (JP); Yuji Fujimoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA

(21) Appl. No.: 11/589,506

(22) Filed: Oct. 30, 2006

(30) Foreign Application Priority Data
Jun. 21, 2006 (JP) P2006-171222

(51) Int. Cl. H04Q 7/20

(52) U.S. Cl. 455/425

(57) ABSTRACT

According to an aspect of the invention, there is provided an information processing device including: a display unit configured to display a plurality of setting informations of a setting of function indicated by indication information displayed on a standby screen; a key unit configured to accept a selection of one piece of setting information among the plurality of setting informations; a control unit configured to cancel or change function setting, based on the setting information of which the selection is accepted by the key unit; and a display control unit configured to control a display of the indication information, which is performed by the display unit, in accordance with the cancel or the change of function setting performed by the control unit.

### CROSS-REFERENCE TO RELATED APPLICATIONS

This application is based upon and claims the benefit of priority from the prior Japanese Patent Application No. 2006-171222, filed on Jun. 21, 2006; the entire contents of which are incorporated herein by reference.

### TECHNICAL FIELD

The present invention relates to an information processing device, and more specifically, to an information processing device which can display function setting as an icon on a standby screen.

### BACKGROUND

### Description of Related Art

Recently, mobile phones have a significantly large number of functions mounted thereon. In order to simply perform the setting of functions to be manipulated, a large number of functions are previously classified by type or purpose, and a setting menu of each function is hierarchized.

A user suitably sets each function in accordance with his/her taste, by using such a hierarchized setting menu of each function. However, it is difficult to remember all setting states of the respective functions. Therefore, icons indicating the setting states of the respective functions are displayed on a standby screen such that the setting states of the respective functions which are previously set can be easily viewed by a user.

As a related-art method of displaying icons indicating the setting states of functions on a standby screen, the following method is proposed. While a display screen is effectively used, a function setting menu is simply called so that function setting is smoothly and rapidly (for example, refer to JP-A-2003-298715).

According to a the related-art method, a dial lock/secret mode setting notice icon and the like are displayed on the upper edge region of a standby screen, and a vibrator setting notice icon and the like are displayed on the lower edge region of the standby screen. Further, when a user manipulates a manipulation key, for example, when a user selects the vibrator setting notice icon and presses a confirmation key, the standby screen is switched over to a vibrator setting menu.

However, when the setting of functions previously associated with the icons displayed on the standby screen is canceled or changed, a user cancels or changes the function setting by using a predetermined method. Specifically, if a side key is pressed for a long period (for example, about 1 second) in a state where the standby screen is displayed, the mode can be set to a manner mode, and an icon indicating that the mobile phone is currently set in the manner mode is displayed.

Through such a manipulation, the user can change the setting of manner mode.

### SUMMARY

According to an aspect of the invention, there is provided an information processing device including: a display unit configured to display a plurality of setting informations of a setting of function indicated by indication information displayed on a standby screen; a key unit configured to accept a selection of one piece of setting information among the plurality of setting informations; a control unit configured to cancel or change function setting, based on the setting information of which the selection is accepted by the key unit; and a display control unit configured to control a display of the indication information, which is performed by the display unit, in accordance with the cancel or the change of function setting performed by the control unit.

According to another aspect of the invention, there is provided an information processing device including: an key unit configured to accept a selection of one piece of indication information among a plurality of indication informations displayed on a standby screen; a display unit configured to display an editing screen for editing a function indicated by the one piece of indication information, of which the selection is accepted by the indication information accepting unit; and an editing unit configured to edit the function by accepting an indication of function editing.

### BRIEF DESCRIPTION OF THE DRAWING

FIGS. 1A and 1B are exemplary diagrams illustrating the appearance of a digital mobile phone with a camera which can be applied to an information processing device according to embodiments.

FIGS. 2A and 2B are exemplary diagrams illustrating the appearance of the digital mobile phone with a camera which can be applied to an information processing device according to the embodiments.

FIG. 3 is an exemplary block diagram illustrating an internal configuration of the digital mobile phone with a camera which can be applied to an information processing device according to first embodiment of the invention.

FIG. 4 is an exemplary flow chart for explaining indication information display control processing in the digital mobile phone of FIG. 3.

FIG. 5 is an exemplary transition diagram of a display screen which is displayed on a liquid crystal display in the indication information display control processing of FIG. 4.

FIG. 6 is an exemplary flow chart for explaining another indication information display control processing in the digital mobile phone of FIG. 3 according second embodiment of the invention.

FIG. 7 is an exemplary transition diagram of a display screen which is displayed on the liquid crystal display in the indication information display control processing of FIG. 6.

FIG. 8 is an exemplary flow chart for explaining another indication information display control processing in the digital mobile phone of FIG. 3 according a third embodiment of the invention.

FIG. 9 is an exemplary transition diagram of a display screen which is displayed on the liquid crystal display in the indication information display control processing of FIG. 8.

FIGS. 10A to 10E are exemplary diagrams illustrating the transition of indication information which is gradually enlarged so as to be displayed.

FIG. 11 is an exemplary diagram illustrating the transition from indication information to an editing screen which is displayed on the liquid crystal display of FIG. 3.

FIG. 12 is an exemplary flow chart for explaining a still further form of indication information display control processing in the digital mobile phone of FIG. 3.

FIG. 13 is a transition diagram of a display screen which is displayed on the liquid crystal display in the indication information display control processing of FIG. 12 according to an fourth embodiment of the invention.

FIG. 14 is another transition diagram of a display screen which is displayed on the liquid crystal display in the indication information display control processing of FIG. 12.

### DESCRIPTION OF THE EMBODIMENTS

In the related-art method, however, the function setting can be canceled or changed by using a dedicated screen for performing function setting, while the display screen is effectively used. However, when it is not specified which function the icon for performing the setting of each function displayed on the standby screen indicates or in which setting state the icon is set, and when a user does not understand the icon displayed on the standby screen, the user cannot know a method of releasing the icon, either. Therefore, the user purposely examine an instruction book of the mobile phone.

Particularly, when a user unconsciously performs the setting of a predetermined function, or when a user does not know a solution even though examining the instruction book of the mobile phone, it does not occur to the user which portion of the instruction book he/she examines.

Further, when the function setting is canceled or changed by using a dedicated screen for performing function setting, the standby screen is switched over to the dedicated screen for performing function setting, thereby degrading the manipulation of a user.

According to embodiments, there is provided an information processing device which can easily notice the meaning of indication information, displayed on a standby screen, to a user.

According to the embodiments, there is provided an information processing device which can simply and directly perform function setting (for example, change or cancel) on a standby screen by selecting indication information displayed on the standby screen.

Hereinafter, the embodiments of the present invention will be described with reference to accompanying drawings.

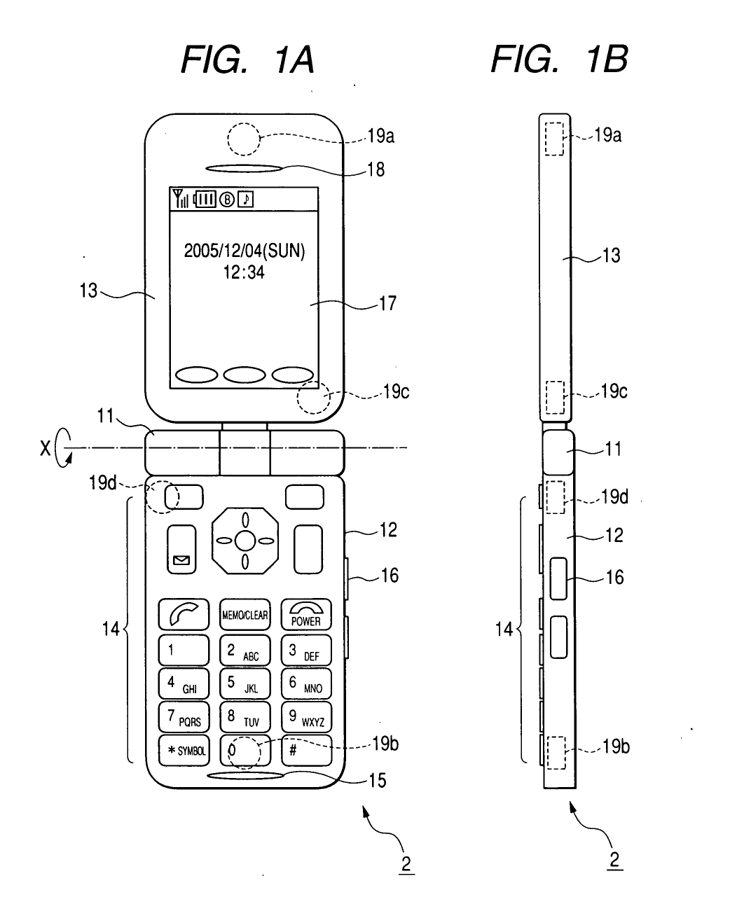

FIGS. 1A and 1B are diagrams illustrating the appearance of a digital mobile phone 2 with a camera which can be applied as an information processing device according to the embodiments. FIG. 1A is a front view of the digital mobile phone 2 when the digital mobile phone 2 is opened at about 180 degrees, and FIG. 1B is a side view of the digital mobile phone 2 when the digital mobile phone 2 is opened.

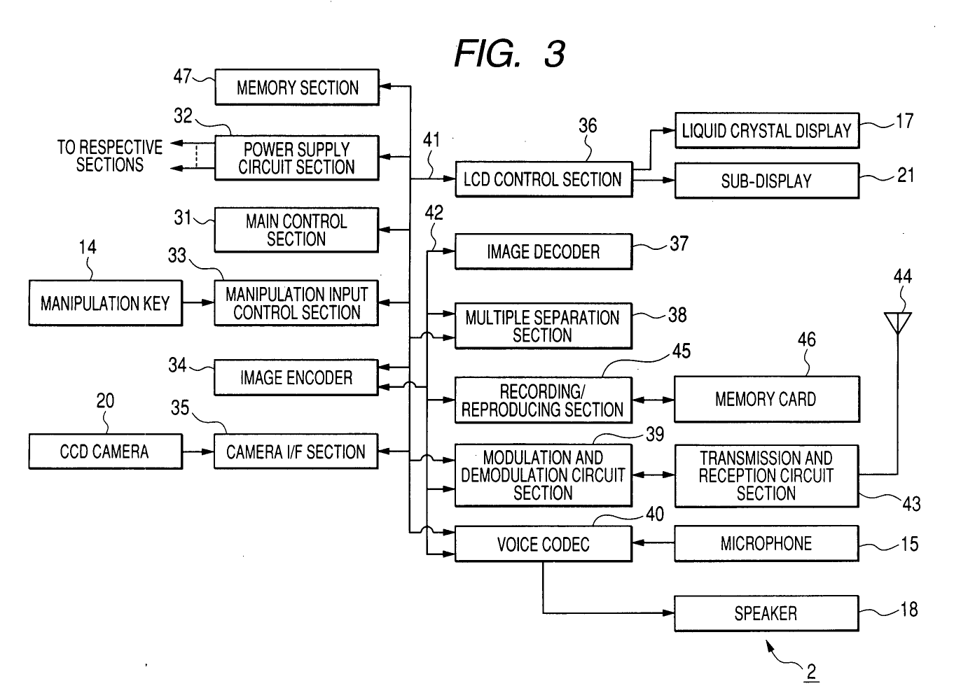

As shown in FIGS. 1A and 1B, the digital mobile phone 2 with a camera includes a first case 12 and a second case 13 which are hinge-coupled with a central hinge portion 11 set to a border therebetween. The digital mobile phone 2 can be folded in a direction of an arrow X of FIG. 1A. In a predetermined position inside the digital mobile phone 2, an antenna (an antenna 44 of FIG. 3 to be described below) for transmission and reception is provided, through which the digital mobile phone 2 transmits and receives radio waves to and from a base station (not shown).

The first case 12 includes manipulation keys 14 such as number keys from ‘0’ to ‘9’, a calling key, a redial key, a call-ending/power key, a clear key, and an e-mail key, which are provided on the surface thereof. Various instructions are input by using the manipulation keys 14.

The first case 12 further includes a cross-shape key and a confirmation key as the manipulation keys 14, which are provided on the upper portion thereof. As a user manipulates the cross-shape key in four directions, the user can move a cursor in four directions. Specifically, the user can scroll a telephone number list or e-mail which is being displayed on a liquid crystal display 17 provided on the second case 13, can turn over a simplified home page, or can send an image.

With the confirmation key being pressed, various functions can be confirmed. For example, in accordance with the manipulation of the cross-shape key performed by a user, a desired telephone number is selected from a plurality of telephone numbers in a telephone book displayed on the liquid crystal display 17. As the confirmation key is pressed in an inward direction of the first case 12, the selected telephone number is confirmed, and a call request is made at the telephone number.

The first case 12 further includes an e-mail key provided in the immediate left of the cross-shape key and the confirmation key. When the e-mail key is pressed in the inward direction of the case 12, an e-mail transmission and reception function can be invoked. In the immediate right of the cross-shape key and the confirmation key, a browser key is provided. When the browser key is pressed in the inward direction of the first case 12, data of a web-page can be browsed. Further, the e-mail key and the browser key provided in the immediate left and right of the cross-shape key and the confirmation key, respectively, are also referred to as soft 1 key and soft 2 key, because they are provided with various functions, such as ‘yes’ or ‘no’ and the like, depending on a screen displayed on the liquid crystal display 17.

The first case 12 further includes a microphone 15 provided under the manipulation keys 14, the microphone 15 collecting voice of a user when the user talks over the mobile phone. Further, the first case 2 includes a side key 16 for performing the manipulation of the mobile phone 2 with a camera.

The first case 12 further includes a battery pack (not shown) inserted in the back side thereof. When the call-ending/power key is turned on, electric power is supplied to circuit sections from the battery pack such that the respective circuit sections can operate.

However, the first case 12 includes a memory card slot (not shown) for inserting an attachable/detachable memory card (a memory card 46 of FIG. 3 to be described below) into a predetermined position in the lower portion of the first case 12. When a memo button (not shown) is pressed, the voice of a person at the other end, who is talking over the phone, can be recorded in the memory card. Further, in accordance with the manipulation of a user, an e-mail, a simplified home page, and an image taken by a CCD camera can be recorded in the memory card.

The memory card is a kind of flash memory card which is represented by a NAND-type or NOR-type flash memory card. The memory card stores a flash memory element in a small-size slim plastic case, the flash memory element being a non-volatile memory which can electrically rewrite and erase data. Various data such as images, voice data, music files and the like can be written into or read from the memory card through a 10-pin terminal.

In order to implement high-speed performance, the memory card adopts a unique serial protocol which can secure compatibility with an equipment to be used, even though the specification of built-in flash memory is changed as a memory capacity increases. Further, the memory card includes a safety switch which prevents erasing from being performed improperly, thereby securing high reliability.

Accordingly, since the mobile phone 2 with a camera has such a structure that the memory card can be inserted therein, data can be shared between the mobile phone 2 and another electronic equipment through the memory card.

Further, a module (chip) for extending a predetermined function is embedded in a memory card such that the memory card is mounted on a memory card slot (not shown). Then, it is possible to further extend a function of the digital mobile phone 2 with a camera.

For example, as a memory card having a non-contact IC (integrated circuit) chip embedded therein is mounted on the digital mobile phone 2 with a camera, the function of the digital mobile phone 2 can be extended such that the digital mobile phone 2 has functions such as an electronic payment function and the like, even though a non-contact IC chip is not built in the mobile phone 2.

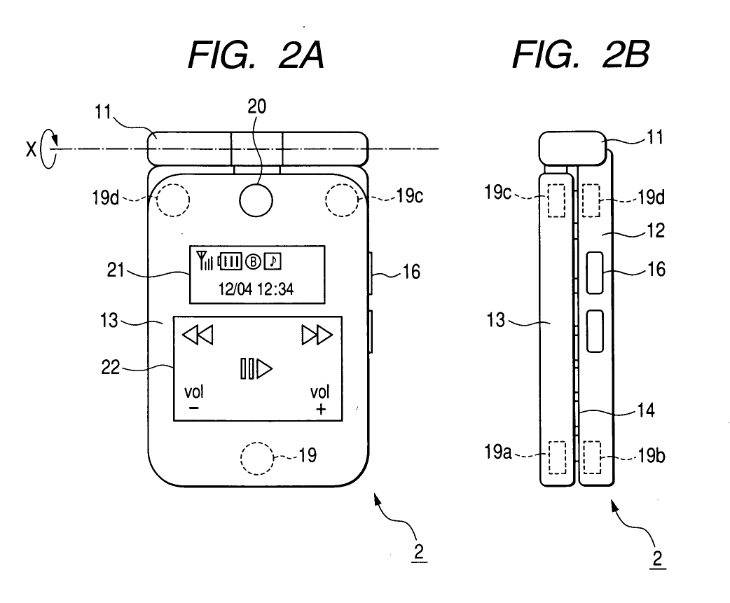

Meanwhile, the second case 13 includes a liquid crystal display (main display) 17 provided on the front surface thereof. The liquid crystal display 17 can display a reception state of radio waves (shown by an antenna pictogram indicating a current sensitivity level of an antenna), a remaining battery level, the name and telephone number of a person at the other end which is registered in a telephone book, and a transmission history. Further, the liquid crystal display 17 can display the contents of an e-mail, a simplified home page, an image taken by a CCD (Charge Coupled Device) camera (a CCD camera 20 of FIG. 2 to be described below), contents received from an external contents server (not shown), and contents stored in a memory card (a memory card 46 of FIG. 3 to be described below). Further, a speaker 18 is provided in a predetermined position above the liquid crystal display 17 such that a user can perform voice communication.

In predetermined positions of the first and second cases 12 and 13, magnetic sensors 19a, 19b, 19c, and 19d are provided so as to detect a state of the digital mobile phone 2 with a camera.

FIGS. 2A and 2B are diagrams illustrating the appearance of the digital mobile phone 2 with a camera which can be applied as the information processing device according to the embodiments. FIG. 2A shows that the digital mobile phone 2 is rotated in a direction of an arrow X from the state of the digital mobile phone 2 of FIG. 1A. FIG. 2A is a front view of the digital mobile phone 2 when the digital mobile phone 2 is closed, and FIG. 2B is a side view of the digital mobile phone 2 when the digital mobile phone 2 is closed.

The second case 13 includes a CCD camera 20 provided in the upper portion thereof. Using the CCD camera 20, a predetermined object can be imaged. Under the CCD camera 20, a sub-display 21 is provided so as to display an antenna pictogram indicating a current sensitivity level of an antenna, a battery pictogram indicating a current remaining battery level of the digital mobile phone 2, a current time and the like.

Under the sub-display 21, an electrostatic touch pad 22 is provided. The electrostatic touch pad 22 seems like one sheet of touch pad. However, the electrostatic touch pad 22 includes sensors (not shown) provided in a plurality of places thereof. When a user touches the vicinity of one sensor, the sensor detects the touching such that a rewind function, a fast-forward function, a volume-down operation, a volume-up operation, a reproducing operation, a pause operation and the like are executed.

FIG. 3 is a diagram showing an internal configuration of the digital mobile phone 2 with a camera which can be applied as the information processing device according a first embodiment.

As shown in FIG. 3, the digital mobile phone 2 with a camera includes a main control section 31 which controls the overall respective sections of the first and second cases 12 and 13, a power supply circuit section 32, a manipulation input control section 33, an image encoder 34, a camera interface section 35, an LCD (Liquid Crystal Display) control section 36, a multiple separation section 38, a modulation and demodulation circuit section 39, a voice codec 40, and a memory section 47, which are connected to each other through a main bus 41. Further, the image encoder 34, an image decoder 37, the multiple separation section 38, the modulation and demodulation circuit section 39, the voice codec 40, and a recording/reproducing section 45 are connected to each other through a synchronizing bus 42.

When the call-ending/power key is turned on by the manipulation of a user, the power supply circuit section 32 supplies electric power to the respective sections from the battery pack such that the digital mobile phone 2 with a camera is activated so as to operate.

The main control section 31 is composed of a CPU (Central Processing Unit), a ROM (Read Only Memory), and a RAM (Random Access Memory). The CPU not only executes a variety of processing tasks in accordance with a program stored in the ROM or various application programs loaded in the RAM from the memory section 47, but also generates various control signals to supply to the respective sections in order to control the overall digital mobile camera 2. The RAM properly stores data required when the CPU executes a variety of processing tasks.

The main control section 31 has a timer built therein, the timer accurately measuring a current date and time. A variety of application programs to be executed by the CPU can be previously installed in the ROM or memory section 47. Alternately, a variety of application programs to be executed by the CPU can be downloaded into the digital mobile phone 2 by communication through a base station (not shown) so as to be installed in the memory section 47. Further, a variety of application programs to be executed by the CPU are stored in the memory card 46. Then, the application programs can be read by the recording/reproducing section 45 so as to be installed in the memory section 47.

Based on the control of the main control section 31, the voice codec 40 of the digital mobile phone 2 with a camera converts voice signals, collected by the microphone 15 at the time of verbal communication mode, into digital voice signals to compress. Then, the compressed digital voice signals are spread-spectrum-processed by the modulation and demodulation circuit section 39 and are then transmitted through the antenna 44 after digital-to-analog conversion and frequency conversion is performed by the transmission and reception circuit section 43.

At the time of the verbal communication mode, the digital mobile phone 2 with a camera amplifies the signals received by the antenna 44 and performs frequency conversion and analog-to-digital conversion. Then, reverse spread spectrum processing is performed on the signals by the modulation and demodulation circuit section 39. The signals are decompressed by the voice codec 40 so as to be converted into analog signals. The converted analog signals are output through the speaker 18.

When the digital mobile phone 2 with a camera transmits an e-mail at the data communication mode, text data of an e-mail input by the manipulation of the manipulation keys 14 is transmitted to the main control section 31 through the manipulation input control section 33. In the main control section 31, the text data is spread-spectrum-processed by the modulation and demodulation circuit section 39. Further, after performing digital-to-analog conversion and frequency conversion, the transmission and reception circuit section 43 transmits the text data to a base station (not shown) through the antenna 44.

On the contrary, when the digital mobile phone 2 with a camera receives an e-mail at the data communication mode, reverse spread spectrum processing is performed on signals, received from a base station (not shown) through the antenna 44, by the modulation and demodulation circuit section 39 such that the signals are restored into original text data. Then, the text data is displayed as an e-mail on the liquid crystal display 17 through the LCD control section 36.

In the digital mobile phone 2 with a camera, the received e-mail can be recorded in the memory card 46 through the recording/reproducing section 45 by the manipulation of a user.

When the digital mobile phone 2 with a camera does not transmit an image signal, an image signal taken by the CCD camera 20 is directly displayed on the liquid crystal display 17 through the camera interface section 35 and the LCD control section 36.

When the digital mobile phone 2 with a camera transmits an image signal at the data communication mode, an image signal taken by the CCD camera 20 is supplied to the image encoder 34 through the camera interface section 35.

The image encoder 34 converts the image signal supplied from the CCD camera 20 into an encoded image signal by performing compressing coding in accordance with a predetermined coding method such as MPEG (Moving Picture Experts Group) 4 and the like, and the encoded image signal is delivered to the multiple separation section 38. At this time, the digital mobile phone 2 converts voice, collected by the microphone 15 while the image signal is being taken by the CCD camera 20, into a digital voice signal. Then, the digital voice signal is delivered to the multiple separation section 38 through the voice codec 40.

The multiple separation section 38 multiplexes the encoded image signal supplied from the image encoder 34 and the voice signal supplied from the voice codec 40 by using a predetermined method, and the multiplexed signal obtained as a result is spread-spectrum-processed by the modulation and demodulation circuit section 39. After performing digital-to-analog conversion and frequency conversion, the transmission and reception circuit section 43 transmits the signal through the antenna 44.

Further, the digital mobile phone 2 with a camera can receive data of a web page at the data communication mode.

That is, when the digital mobile phone 2 with a camera transmits data requesting a web page, for example, at the data communication mode, data of the web page is transmitted through a base station (not shown) in accordance with the request. The web-page data is received by the transmission and reception circuit section 43 and the modulation and demodulation circuit section 39 through the antenna 44. The transmission and reception circuit section 43 and the modulation and demodulation circuit section 39 deliver the received web-page data to the main control section 31.

The main control section 31 analyzes the web-page data and creates a screen (image) based on the analysis. The created image is supplied from the main control section 31 through the LCD control section 36 to the liquid crystal display 17 so as to be displayed on the liquid crystal display 17. That is, at least an application program of web browser is installed in the ROM or memory section 47 of the main control section 31, and the CPU of the main control section 31 executes the application program of web browser on the RAM such that the application program functions as a web browser and analyzes web-page data.

When the digital mobile phone 2 with a camera receives a moving image file linked to a web page at the data communication mode, reverse spread spectrum processing is performed on the signal received from a base station (not shown) through the antenna 44 by the modulation and demodulation circuit section 39, and the multiplexed signal obtained as a result is delivered to the multiple separation section 38.

The multiple separation section 38 separates the multiplexed signal into an encoded image signal and a voice signal. The encoded image signal is supplied to the image decoder 37 through the synchronizing bus 42, and the voice signal is supplied to the voice codec 40. The image decoder 37 decodes the encoded image signal by using a decoding method corresponding to a predetermined encoding method such as MPEG4, thereby generating a reproduced moving image signal. The reproduced moving image signal is supplied to the liquid crystal display 17 through the LCD control section 36. Accordingly, moving image data included in the moving image file linked to a web-page is displayed.

At this time, the voice codec 40 converts the voice signal into an analog voice signal to supply to the speaker 18. Then, the voice signal included in the moving image file liked to a web page is reproduced. Similar to the case of an e-mail, data linked to a received web page can be recorded into the memory card 46 through the recording/reproducing section 45 by the manipulation of a user.

For example, the memory section 47 is a flash memory element as a non-volatile memory in which rewriting and erasing can be electrically performed. The memory section 47 stores various application programs and various data groups which are executed by the CPU of the main control section 31. Further, the memory section 47, if necessary, stores moving image data included in a moving image file linked to a received e-mail or a received web page in accordance with the manipulation of a user.

### FIRST EMBODIMENT

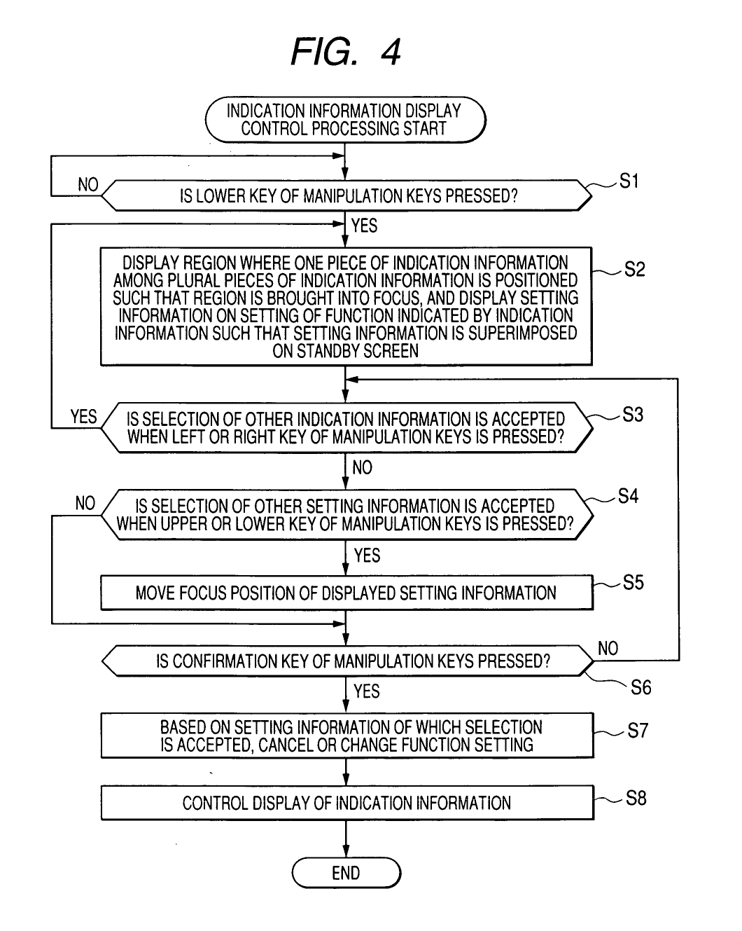

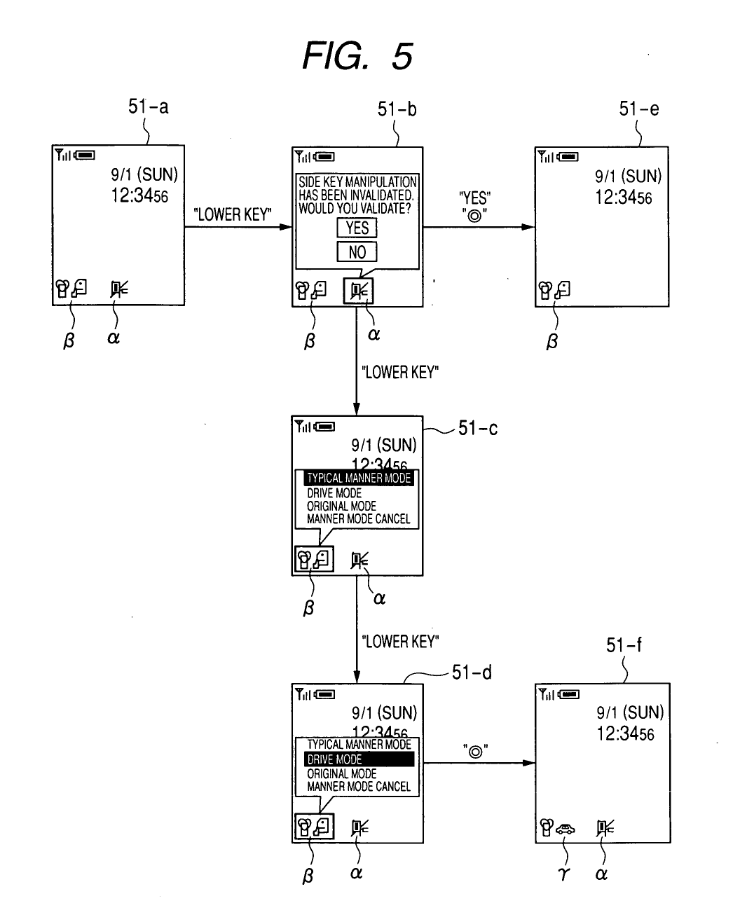

Referring to a flowchart of FIG. 4, indication information display control processing in the digital mobile phone 2 of FIG. 3 will be described. Before the indication information display control processing is performed, a standby screen 51-a of FIG. 5 is first displayed on the liquid crystal display 17. As a user manipulates the cross-shape key (lower key) of the manipulation keys 14, the indication information display control processing begins.

FIG. 5 shows the transition of a display screen displayed on the liquid crystal display 17 in the indication information display control processing of FIG. 4. On the standby screen 51-a, icons α and β are shown. The icon α indicates a state where a side-key manipulation invalidating function is set, and the icon β indicates a state where a manner mode is set to a typical manner mode. The icons α and β are defined as ‘indication information’.

In step S1, the manipulation input control section 33 of the main control section 31 judges whether the cross-shape key (lower key) of the manipulation keys 14 is pressed by a user or not, and the main control section 31 waits until it is judged whether the cross-shape key (lower key) of the manipulation keys 14 is pressed by a user.

When it is judged in step S1 that the cross-shape key (lower key) of the manipulation keys 14 is pressed by a user, the main control section 31 controls the LCD control section 36 such that a region, where one piece of indication information (for example, the icon α of the standby screen 51-a of FIG. 5) among the plural pieces of indication information (for example, the icons α and β of the standby screen 51-a of FIG. 5) is positioned, is brought into focus so as to be displayed on the liquid crystal display 17 (step S2). Further, setting information on the setting of function indicated by the indication information (for example, the icon α of the standby screen 51-a of FIG. 5) is superimposed on the standby screen 51-a so as to be displayed on the liquid crystal display 17.

In accordance with the control of the LCD control section 36, the liquid crystal display 17 displays a setting information display screen 51-b of FIG. 5. In the case of the setting information display screen 51-b of FIG. 5, the side-key manipulation invalidating function is set. Therefore, as the setting information on the setting of function indicated by indication information (for example, the icon α of the standby screen 51-a of FIG. 5), a message dialogue saying ‘Side-key manipulation has been invalidated. Would you validate?’ is displayed. Further, under the message dialogue, command display columns such as ‘Yes’ and ‘No’ are displayed as setting information. Accordingly, a user is able to know that the side-key manipulation invalidating function is currently set. Further, the user is able to know that the setting of side-key manipulation invalidating function can be canceled by the following processing. The setting information on the setting of function indicated by the indication information displayed on the liquid crystal display 17 can include various contents depending on the function.

In step S3, the manipulation input control section 33 of the main control section 31 judges whether or not the selection of other indication information is accepted when the cross-shape key (left or right key) of the manipulation keys 14 is pressed by a user.

When it is judged in the step S3 that the selection of other indication information is accepted with the cross-shape key (left or right key) of the manipulation keys 14 being pressed by a user, the process returns to the step S2. The setting information on the setting of function indicated by the indication information of which the selection is accepted is displayed on the liquid crystal display 17.

That is, in the case of FIG. 5, when the cross-shape key (left key) of the manipulation keys 14 is pressed by a user in a state where the setting information display screen 51-b is being displayed, the selection of the icon β as other indication information is accepted. Then, a setting information display screen 51-c is displayed on the liquid crystal display 17.

In the case of the setting information display screen 51-c of FIG. 5, plural pieces of setting information on various manner modes (for example, typical manner mode, drive mode, original mode, and manner mode cancel) which can be set as a manner mode are displayed as setting information on the setting of function indicated by the indication information (the icon α of the standby screen 51-a of FIG. 5). Further, since the manner mode is set to a typical manner mode, a region in which the setting information on the typical manner mode is displayed is brought into focus. Accordingly, a user can know that the setting information in the manner mode includes the typical manner mode, the drive move, the original mode, and the manner mode cancel and the typical manner mode is currently set.

When it is judged in the step S3 that the selection of other indication information is not accepted when the cross-shape key (left or right key) of the manipulation keys 14 is pressed by a user, the main control section 31 judges whether or not the selection of other setting information is accepted when the cross-shape key (upper or lower key) of the manipulation keys 14 is pressed by a user (step S4).

When it is judged in the step S4 that the selection of other setting information is accepted with the cross-shape key (upper or lower key) of the manipulation keys 14 being pressed by a user, the control section 31 controls the LCD control section 36 such that the focus position of the setting information displayed on the liquid crystal display 17 is moved (step S5). In accordance with the control of the LCD control section 36, the liquid crystal display 17 displays the moved focus position of the setting information.

For example, when the cross-shape key (upper or lower key) of the manipulation keys 14 is pressed one time by a user, the setting information display screen 51-c of FIG. 5 is transited to a setting information display screen 51-d. In the case of the setting information display screen 51-d of FIG. 5, a region where setting information of the drive mode is being displayed is brought into focus.

When it is judged in the step S4 that that the selection of other setting information is not accepted with the cross-shape key (upper or lower key) of the manipulation keys 14 being pressed by a user, the processing task of the step S5 is skipped, and the process proceeds to step S6.

In step S6, the manipulation input control section 33 of the main control section 31 judges whether the confirmation key of the manipulation keys 14 is pressed by a user or not.

When it is judged in the step S6 that the confirmation key of the manipulation keys 14 is pressed by a user, the main control section 31 cancels or changes the setting of function, based on the setting information of which the selection is accepted (step S7). After that, the main control section 31 stores data on the cancel or change of the function setting into the memory section 47. In accordance with the control of the main control section 31, the memory section 47 stores the data on the cancel or change of the function setting.

In the case of the setting information display screen 51-b of FIG. 5, when the confirmation key of the manipulation keys 14 is pressed by a user, the setting of side-key manipulation invalidating function is canceled based on the setting information (the command display column of ‘Yes’) of which the selection is accepted. After that, the main control section 31 stores data on the setting cancel of the side-key manipulation invalidating function into the memory section 47.

In the case of the setting information display screen 51-d of FIG. 5, when the confirmation key of the manipulation keys 14 is pressed by a user, the setting of manner mode is changed from the typical mode to the drive mode, based on the setting information (such as the drive mode) of which the selection is accepted. After that, the main control section 31 stores data on the change in the setting of manner mode into the memory section 47.

In step S8, the main control section 31 controls display of the indication information displayed on the standby screen, in accordance with the cancel or change of the function setting. That is, the main control section 31 controls the LCD control section 36 such that the indication information displayed on the standby screen is not displayed on the liquid crystal display 17 or is changed into other indication information so as to be displayed, in accordance with the cancel or change of the function setting.

Specifically, in the case of a standby screen 51-e of FIG. 5, when the confirmation key of the manipulation keys 14 is pressed by a user, the setting of side-key manipulation invalidating function is canceled, and the indication information (icon α) is not displayed, which indicates that the side-key invalidating function displayed on the standby screen 51-a is being set.

In the case of a standby screen 51-f of FIG. 5, when the confirmation key of the manipulation keys 14 is pressed by a user, the setting of manner mode is changed from the typical manner mode to the drive mode. Further, the indication information (icon β), indicating that the manner mode is being set to the typical manner mode displayed on the standby screen 51-a, is changed into indication information (icon γ) indicating that the manner mode is set to the drive mode.

Accordingly, a user can know current function setting by using the indication information (icon) displayed on the standby screen after the change in indication information.

In the first embodiment of the invention, the setting information on the setting of function indicated by the indication information displayed on the standby screen is displayed on the liquid crystal display 17, and the cancel or change of the function setting is performed based on the setting information. In accordance with that, the indication information to be displayed on the standby screen is not displayed or is changed into other indication information so as to be displayed. Therefore, the meaning of the indication information displayed on the standby screen can be easily noticed to a user. Further, even when a user unconsciously performs function setting, the user can easily grasp the function indicated by the indication information displayed on the standby screen. Further, a user can easily cancel or change the function setting by using the indication information displayed on the standby screen.

Since the setting information on the setting of function indicated by indication information is displayed so as to be superimposed on the standby screen, a user can select the indication information displayed on the standby screen without purposely switching over to a setting screen different from the standby screen. In this case, the cancel or change of the function setting can be directly performed on the standby screen by using the indication information (setting information) displayed on the standby screen. Accordingly, it is possible to enhance the manipulation of the digital mobile phone with a camera. In the indication information display control processing described by using the flow chart of FIG. 4, when the selection of one piece of indication information among the plural pieces of indication information displayed on the standby screen is accepted, the setting information is displayed so as to be superimposed on the standby screen. However, after the selection of one piece of indication information among the plural pieces of indication information displayed on the standby screen is accepted, the confirmation key is pressed by a user. Then, the setting information may be displayed so as to be superimposed on the standby screen. Accordingly, while the liquid crystal display 17 is effectively used, the indication information display control processing can be executed in accordance with a timing of a user, which makes it possible to further enhance the manipulation of the digital mobile phone 2 with a camera.

### SECOND EMBODIMENT

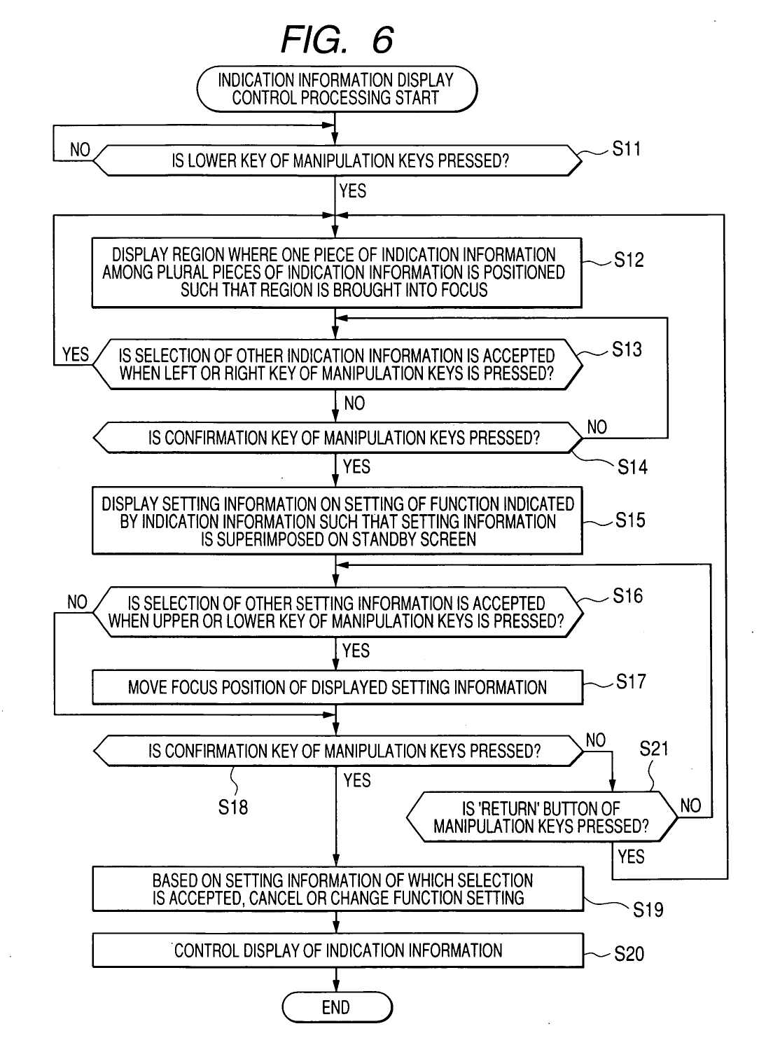

Referring to a flow chart of FIG. 6, another form of indication information display control processing in the digital mobile phone 2 of FIG. 3 will be described. The processing tasks of steps S19 and S20 of FIG. 6 are the same as those of steps S7 and S8 of FIG. 4, and the descriptions thereof will be omitted.

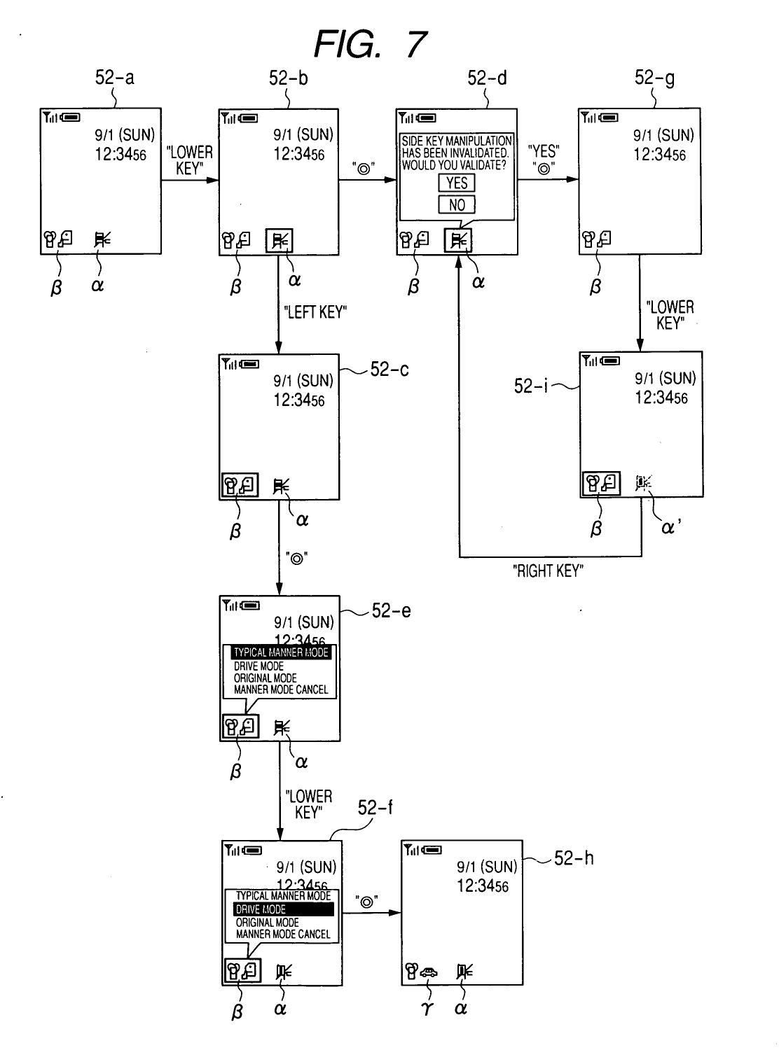

Before the indication information display control processing is executed, a standby screen 52-a of FIG. 7 is first displayed on the liquid crystal display 17. As the cross-shape key (lower key) of the manipulation keys 14 is manipulated by a user, the indication information display control processing begins. FIG. 7 shows the transition of the display screen displayed on the liquid crystal display 17 in the indication information display control processing of FIG. 6. On the standby screen 52-a, there are shown the indication information (icon α) indicating that the side-key manipulation invalidating function is set and the indication information (icon β) indicating that a manner mode is set to the typical manner mode.

In step S11, the manipulation input control section 33 of the main control section 31 judges whether the cross-shape key (lower key) of the manipulation keys 14 is pressed by a user or not, and the main control section 31 waits until it is judged that the cross-shape key (lower key) of the manipulation keys 14 is pressed by a user.

When it is judged in step S11 that the cross-shape key (lower key) of the manipulation keys 14 is pressed by a user, the main control section 31 controls the LCD control section 36 such that a region, where one piece of indication information (for example, the icon α on the standby screen 52-a of FIG. 7) among plural pieces of indication information (for example, the icons α and β on the standby screen 52-a of FIG. 7) is positioned, is brought into focus such that the standby screen 52-b is displayed on the liquid crystal display 17 (step S12).

In step S13, the manipulation input control section 33 of the main control section 31 judges whether or not the selection of other indication information is accepted when the cross-shape key (left or right key) of the manipulation keys 14 is pressed by a user.

When it is judged in the step S13 that the selection of other indication information is accepted when the cross-shape key (left or right key) of the manipulation keys 14 is pressed by a user, the process returns to the step S12, and a region where the indication information (for example, the icon β on the standby screen 52-b of FIG. 7), of which the selection is accepted in the step S13, is positioned is brought into focus such that a standby screen 52-c is displayed on the liquid crystal display 17.

When it is judged in the step S13 that the selection of other indication information is not accepted when the cross-shape key (left or right key) of the manipulation keys 14 is pressed by a user, the main control section 31 judges whether the confirmation key of the manipulation keys 14 is pressed by a user or not (step S14).

When it is judged in the step S14 that the confirmation key of the manipulation keys 14 is not pressed by a user, the process returns to the step S13, and processing tasks following the step S13 are repeated.

When it is judged in the step S14 that the confirmation key of the manipulation keys 14 is pressed by a user, the main control section 31 controls the LCD control section 36 such that setting information on the setting of function indicated by the indication information (for example, the icon α on the standby screen 52-b of FIG. 7) is superimposed on the standby screen 52-b so as to be displayed on the liquid crystal display 17 (step S15).

In accordance with the control of the LCD control section 36, the liquid crystal display 17 displays a setting information display screen 52-d of FIG. 7. In the case of the setting information display screen 52-d, the side-key invalidating function has been set. Therefore, as the setting information on the setting of function indicated by the indication information (for example, the icon α on the standby screen 52-b of FIG. 7), a message dialogue saying ‘Side-key manipulation has been invalidated. Would you validate?’ is displayed. Further, under the message dialogue, command display columns such as ‘Yes’ and ‘No’ are displayed as setting information. Accordingly, a user is able to know that the side-key manipulation invalidating function is currently set. Further, the user is able to know that the setting of side-key manipulation invalidating function can be canceled by the following processing task.

In the case of the setting information display screen 52-e of FIG. 7, plural pieces of setting information on various manner modes (for example, typical manner mode, drive mode, original mode, and manner mode cancel) which can be set as a manner mode are displayed as setting information on the setting of function indicated by the indication information (the icon β of the standby screen 51-c of FIG. 5). Further, since the manner mode is set to the typical manner mode, a region where the setting information of the typical manner mode is displayed is brought into focus. Accordingly, a user can know that the setting information on the manner mode includes the typical manner mode, the drive move, the original mode, and the manner mode cancel and the typical manner mode is currently set.

In step S16, the main control section 31 judges whether or not the selection of other setting information is accepted when the cross-shape key (upper or lower key) of the manipulation keys 14 is pressed by a user.

When it is judged in the step S16 that the selection of other setting information is accepted when the cross-shape key (upper or lower key) of the manipulation keys 14 is pressed by a user, the main control section 31 controls the LCD control section 36 such that the focus position of the setting information displayed on the liquid crystal display 17 is moved (step S17). In accordance with the control of the LCD control section 36, the liquid crystal display 17 displays the moved focus position of the setting information displayed on the liquid crystal display 17.

For example, when the cross-shape key (upper or lower key) of the manipulation keys 14 is pressed one time by a user, the setting information display screen 52-e of FIG. 7 is transited into a setting information display screen 52-f. In the case of the setting information display screen 52-f of FIG. 7, a region where the setting information of drive mode is displayed is brought into focus so as to be displayed.

When it is judged in the step S16 that the selection of other setting information is accepted with the cross-shape key (upper or lower key) of the manipulation keys 14 being pressed by a user, the processing task of the step S17 is skipped, and the process proceed to step S18.

In step S18, the manipulation input control section 33 of the main control section 31 judges whether the confirmation key of the manipulation keys 14 is pressed by a user or not.

When it is judged in the step S18 that the confirmation key of the manipulation keys 14 is pressed by a user, the main control section 31 performs the cancel or change of the function setting (step S19). After that, the display of indication information is controlled in step S20.

When it is judged in the step S18 that the confirmation key of the manipulation keys 14 is pressed by a user, the main function 31 judges whether one key (for example, the soft 2 key) of the manipulation keys 14 corresponding to ‘return’ is pressed by a user or not (step S21).

When it is judged in the step S21 that the key (for example, the soft 2 key) of the manipulation keys 14 corresponding to ‘return’ is pressed by a user, the process returns to the step S12, and the processing tasks following the step S12 are repeated.

That is, the screen returns to the standby screen 52-b or 52-c such that the same indication information display control processing is executed.

Meanwhile, when it is judged in the step S21 that the key (for example, the soft 2 key) of the manipulation keys 14 corresponding to ‘return’ is not pressed by a user, the process proceeds to the step S16, and the processing tasks following the step S16 are repeated. Accordingly, until the confirmation key of the manipulation keys 14 or the ‘return’ button is pressed, the user can select a desired piece of setting information among the plural pieces of setting information on the same setting information display screen (for example, the setting information display screens 52-d, 52-e, and 52-f of FIG. 7).

In the second embodiment of the invention, the setting information on the setting of function indicated by the indication information displayed on the standby screen is displayed on the liquid crystal display 17, and the cancel or change of the function setting is performed based on the setting information. In accordance with that, the indication information to be displayed on the standby screen is not displayed or is changed into other indication information so as to be displayed. Therefore, the meaning of the indication information displayed on the standby screen can be easily noticed to a user. Further, even when a user unconsciously performs function setting, the user can easily grasp the situation by viewing the function indicated by the indication information displayed on the standby screen. Further, a user can easily cancel or change the function setting by using the indication information displayed on the standby screen.

While the liquid crystal display 17 is effectively used, the setting information on the setting of function indicated by indication information is displayed so as to be superimposed on the standby screen, in accordance with a timing of a user. Therefore, the user can select the indication information displayed on the standby screen without purposely switching over to a setting screen different from the standby screen. In this case, the cancel or change of the function setting can be directly performed on the standby screen by using the indication information (setting information) displayed on the standby screen. Accordingly, it is possible to further enhance the manipulation of the digital mobile phone with a camera.

When indication information is displayed in FIG. 7, indication information corresponding to a function of which the setting is currently canceled is displayed to be half-transparent (or by a dotted line) like an icon α′, not a solid line, as shown in a standby screen 52-I of FIG. 7. Further, the function may be again set by using the indication information (the icon α′). After that, the standby screen 52-i is transited into the standby screen 52-d, and the indication information (the icon α′) corresponding to the function which is once again set is displayed by a solid line like the icon α. Further, when the indication information (icon) corresponding to the function of which the setting is currently canceled is displayed, the indication information may be displayed on the lower stage of a line, where the indication information (icon) corresponding to a function which is not currently set is displayed, by a solid line, half-transparence, or a dotted line.

However, depending on a function (for example, memo pad function or the like) mounted on the digital mobile phone 2 with a camera, the setting information on the setting of function is not displayed to be superimposed on the standby screen, but an editing screen for editing a function on the standby screen can be displayed. In this case, a user easily performs the manipulation. Accordingly, when the selection of indication information on the standby screen is accepted with the manipulation keys 14 being manipulated by a user, an editing screen for editing the function indicated by the indication information of which the selection is accepted may be displayed so as to be superimposed on the standby screen. Accordingly, the user can directly manipulate the indication information displayed on the standby screen, which makes it possible to further enhance the manipulation of the digital mobile phone 2 with a camera. Hereinafter, the indication information display control processing in this case will be described.

### THIRD EMBODIMENT

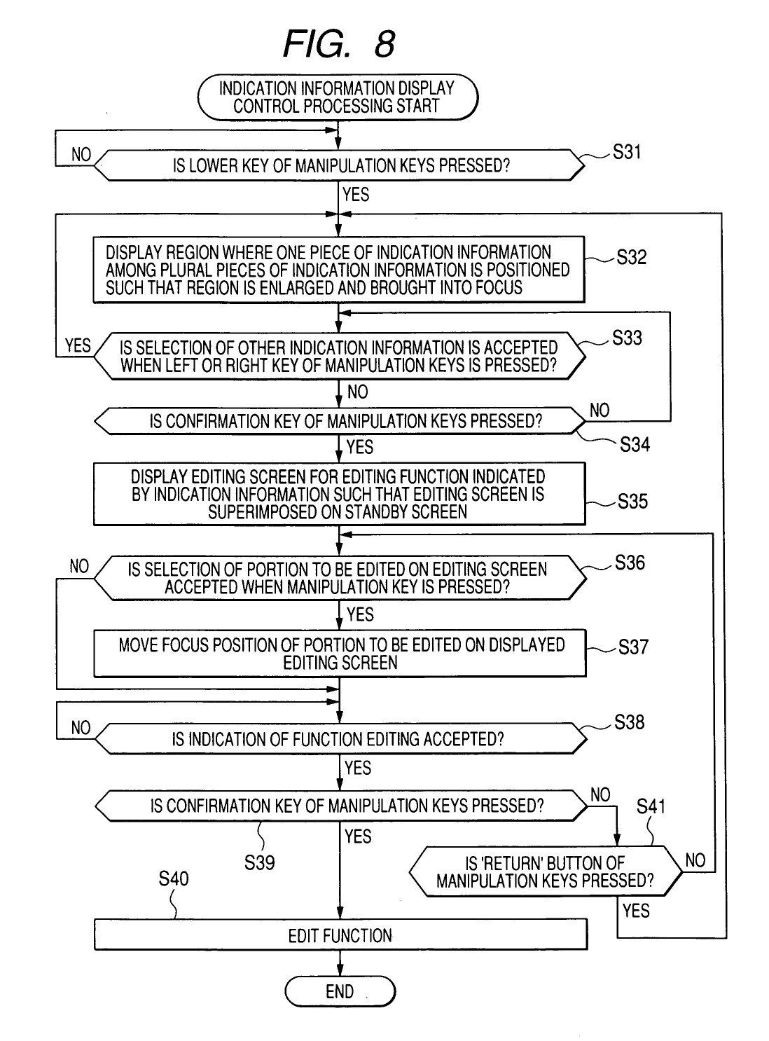

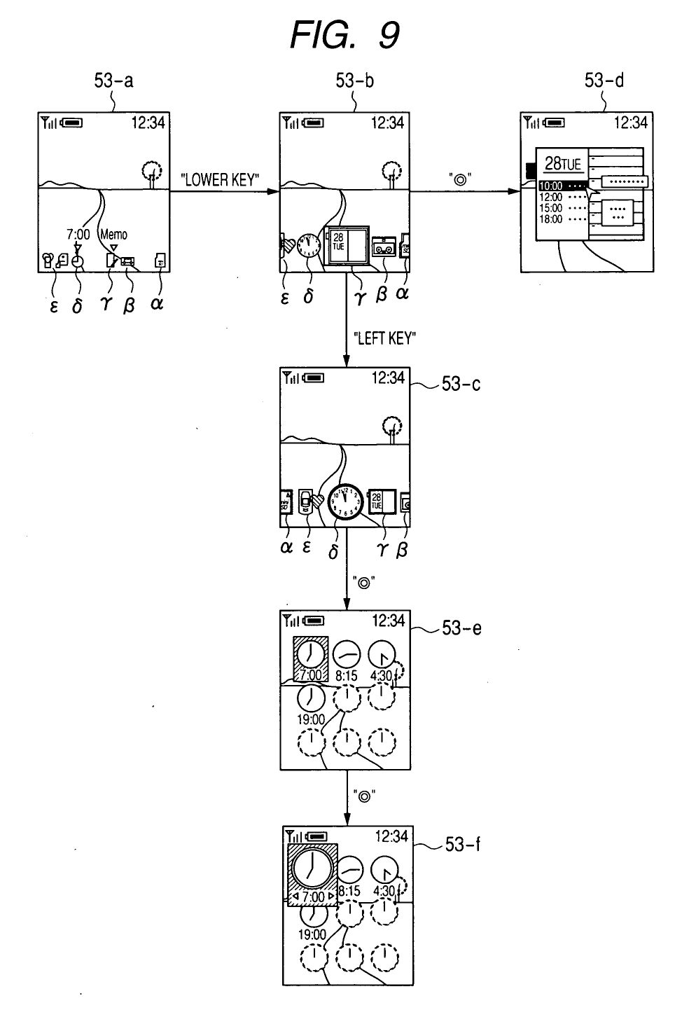

Referring to a flow chart of FIG. 8, a further form of indication information display control processing in the digital mobile phone 2 of FIG. 3 will be described. Before the indication information display control processing is performed, a standby screen 53-a of FIG. 9 is first displayed on the liquid crystal display 17. As a user manipulates the cross-shape key (lower key) of the manipulation keys 14, the indication information display control processing begins.

FIG. 9 shows the transition of the display screen displayed on the liquid crystal display 17 in the indication information display control processing of FIG. 8. Further, on the standby screen 53-a, there are displayed indication information (icon α) indicating a function of browsing the memory card 46, indication information (icon β) indicating an answering machine function, indication information (icon γ) indicating a memo pad function, indication information (icon δ) indicating an alarm function, and indication information (icon ε) indicating that the manner mode is set to the typical manner mode.

In step S31, the manipulation control section 33 of the main control section 31 judges whether the cross-shape key (lower key) of the manipulation keys 14 is pressed by a user or not, and the main control section 31 waits until it is judged that the cross-shape key (lower key) of the manipulation keys 14 is pressed by a user.

When it is judged in the step S31 that the cross-shape key (lower key) of the manipulation keys 14 is pressed by a user, the main control section 31 controls the LCD control section 36 such that plural pieces of indicating information (for example, the icons α to ε of the standby screen 53-a of FIG. 9) are enlarged and displayed (step S32). Further, one piece of indication information (for example, the icon γ of the standby screen 53-b of FIG. 9) among them is further enlarged and brought into focus such that the standby screen 53-b is displayed on the liquid crystal display 17.

In step S33, the manipulation control section 33 of the main control section 31 judges whether or not the selection of other indication information is accepted when the cross-shape key (left or right key) of the manipulation keys 14 is pressed by a user.

When it is judged in the step S33 that the selection of other indication information is accepted with the cross-shape key (left or right key) of the manipulation keys 14 being pressed by a user, the process returns to the step S32, and the indication information (for example, the icon γ of the standby screen 53-b of FIG. 9) of which the selection is accepted is further enlarged and brought into focus such that a standby screen 53-c is displayed on the liquid crystal display 17.

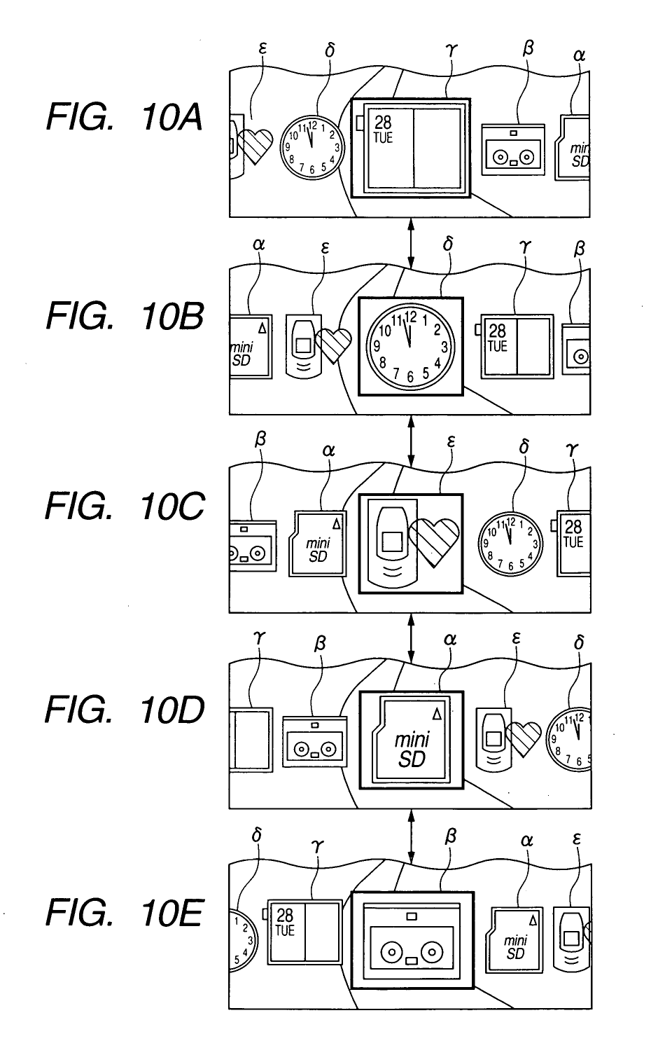

When a user repeatedly presses the left key of the manipulation keys 14, the indication information (for example, the icons α to ε of the standby screen 53-a of FIG. 9) of which the selection is accepted is further enlarged and brought into focus in a predetermined order (in an order of the icon γ→the icon δ→the icon ε→the icon α→the icon β→the icon γ) such that a standby screen 53-c is displayed the liquid crystal display 17, as shown in FIGS. 10A to 10E.

On the contrary, when a user repeatedly presses the right key of the manipulation keys 14, the indication information (for example, the icons α to ε of the standby screen 53-a of FIG. 9) of which the selection is accepted is further enlarged and brought into focus in a predetermined order (in an order of the icon γ→the icon β→the icon α→the icon ε→and the icon δ→the icon γ) such that a standby screen 53-c is displayed on the liquid crystal display 17, as shown in FIGS. 10A to 10E.

When it is judged in the step S33 that the selection of other indication information is not accepted with the cross-shape key (left or right key) of the manipulation keys 14 being pressed by a user, the main control section 31 judges whether the confirmation key of the manipulation keys 14 is pressed by a user or not (step S34).

When it is judged in the step S34 that the confirmation key of the manipulation keys 14 is not pressed by a user, the process returns to the step S33, and the processing tasks following the step S33 are repeated.

When it is judged in the step S34 that that the confirmation key of the manipulation keys 14 is pressed by a user, the control section 31 controls the LCD control section 36 such that an editing screen for editing a function indicated by the indication information (for example, the icon γ of the standby screen 53-b of FIG. 9) is superimposed on the standby screen 53-b so as to be displayed on the liquid crystal display 17 (step S35).

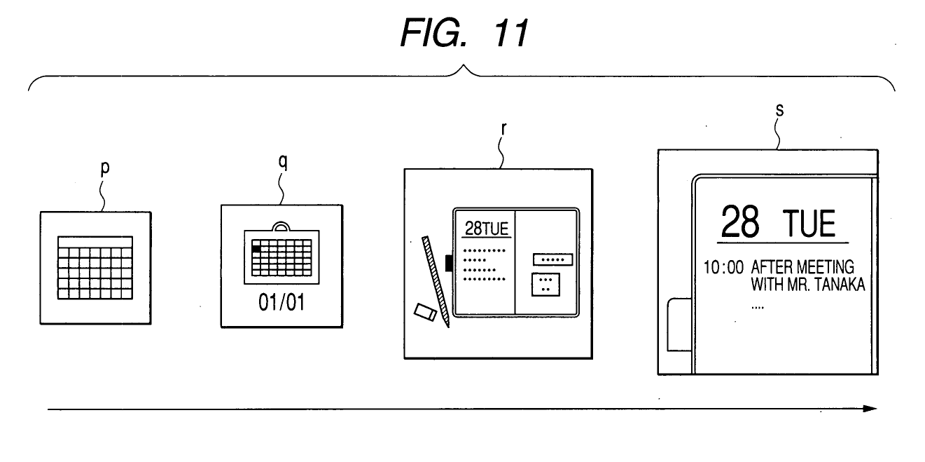

In accordance with the control of the LED control section 36, the liquid crystal display 17 displays an editing screen 53-d of FIG. 9. In the case of the editing screen 53-d of FIG. 9, the editing screen for editing a memo pad function is displayed. Accordingly, a user is able to know that the memo pad function can be edited by the following processing. Further, when the confirmation key of the manipulation keys 14 is pressed by a user, the indication information (for example, the icon γ of the standby screen 53-b of FIG. 9) displayed on the standby screen is gradually enlarged as shown in FIG. 11 (from p to s). As if the indication information displayed on the standby screen is enlarged, the editing screen (for example, the editing screen 53-d of FIG. 9) is displayed.

In the case of the editing screen 53-e of FIG. 9, an editing screen for editing an alarm function is displayed. Accordingly, a user is able to know that an alarm function can be edited by the following processing task.

In step S36, as the cross-shape key (four-direction key) of the manipulation keys 14 is pressed by a user, the main control section 31 judges whether the selection of another portion to be edited on the editing screen is accepted or not.

When it is judged in the step S36 that the selection of another portion to be edited on the editing screen is accepted with the cross-shape key (four-direction key) of the manipulation keys 14 being pressed by a user, the main control section 31 controls the LCD control section 36 so as to move the focus position of the portion to be edited on the editing screen displayed on the liquid crystal display 17 (step S37). In accordance with the control of the LCD control section 36, the liquid crystal display 17 displays the moved focus position of the portion to be edited on the editing screen displayed on the liquid crystal display 17.

In the case of the editing screen 53-d or 53-e of FIG. 9, when the cross-shape key (four-direction key) of the manipulation keys 14 is pressed one time by a user, a focus position of a portion to be edited on the editing screen 53-d or 53-e is moved by one in any one of four directions.

Accordingly, a user can simply edit a function.

When it is judged in the step S36 that the selection of another portion to be edited on the editing screen is not accepted with the cross-shape key (four-direction key) of the manipulation keys 14 being pressed by a user, the processing task of step S37 is skipped, and the process proceeds to step S38.

In the step S38, the manipulation input control section 33 of the main control section 31 judges whether or not indication of function editing is accepted when the manipulation keys 14 are manipulated by a user, and the main control section 31 waits until it is judged that indication of function editing is accepted when the manipulation keys 14 are manipulated by a user.

When it is judged in the step S38 that indication of function editing is accepted with the manipulation keys 14 being manipulated by a user, the manipulation input control section 33 of the main control section 31 judges whether the confirmation key of the manipulation keys 14 is pressed by a user or not (step S39).

When it is judged in the step S39 that the confirmation key of the manipulation keys 14 is pressed by a user, the main control section 31 performs function editing, based on the indication of editing which is accepted with the manipulation keys 14 being manipulated by a user (step S40). Specifically, in the case of the editing screen 53-d of FIG. 9, contents described in a memo pad are edited. Further, in the case of an editing screen 53-e of FIG. 9, when the confirmation key of the manipulation keys 14 is pressed by a user, an editing screen 53-f is displayed so that an alarm time can be edited, for example, from ‘7:00’ to ‘6:30’. The main control section 31 stores the result of function editing into the memory section 47. In accordance with the control of the main control section 31, the memory section 47 stores the result of function editing. After that, the indication information display processing is terminated.

When it is judged in the step S40 that the confirmation key of the manipulation keys 14 is not pressed by a user, the main control section 31 judges whether or not a key (for example, the soft 2 key) of the manipulation keys 14 corresponding to ‘return’ is pressed (step S41).

When it is judged in the step S41 that a key (for example, the soft 2 key) of the manipulation keys 14 corresponding to ‘return’ is pressed, the process returns to the step S32, and the processing tasks following the step S32 are repeated.

When it is judged in the step S41 that a key (for example, the soft 2 key) of the manipulation keys 14 corresponding to ‘return’ is not pressed, the process returns to the step S36, and the processing tasks following the step S36 are repeated.

In the third embodiment, the editing screen of the function indicated by the indication information displayed on the standby screen is displayed so as to be superimposed on the standby screen, and function editing is performed based on the editing indication from a user. Therefore, function editing can be simply performed by using the indication information displayed on the standby screen.

Further, since the editing screen for editing a function displayed by indication information is displayed so as to be superimposed on the standby screen, a user directly performs function editing on the standby screen by using indication information displayed on the standby screen, without purposely switching over to a setting screen different from the standby screen. Accordingly, it is possible to further enhance the manipulation of the digital mobile phone with a camera.

### FOURTH EMBODIMENT

Next, an embodiment different from the above-described embodiments will be described.

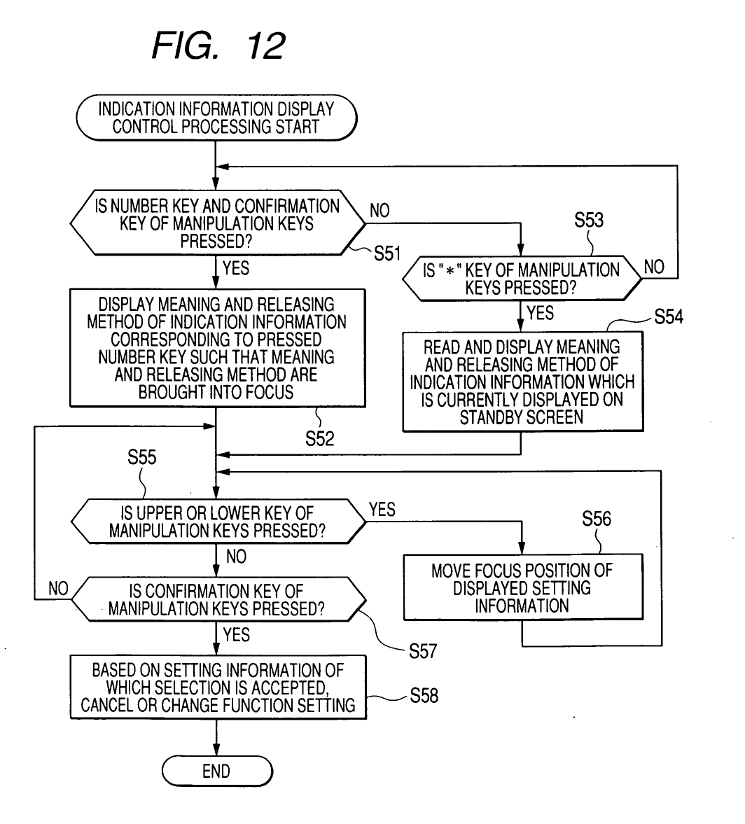

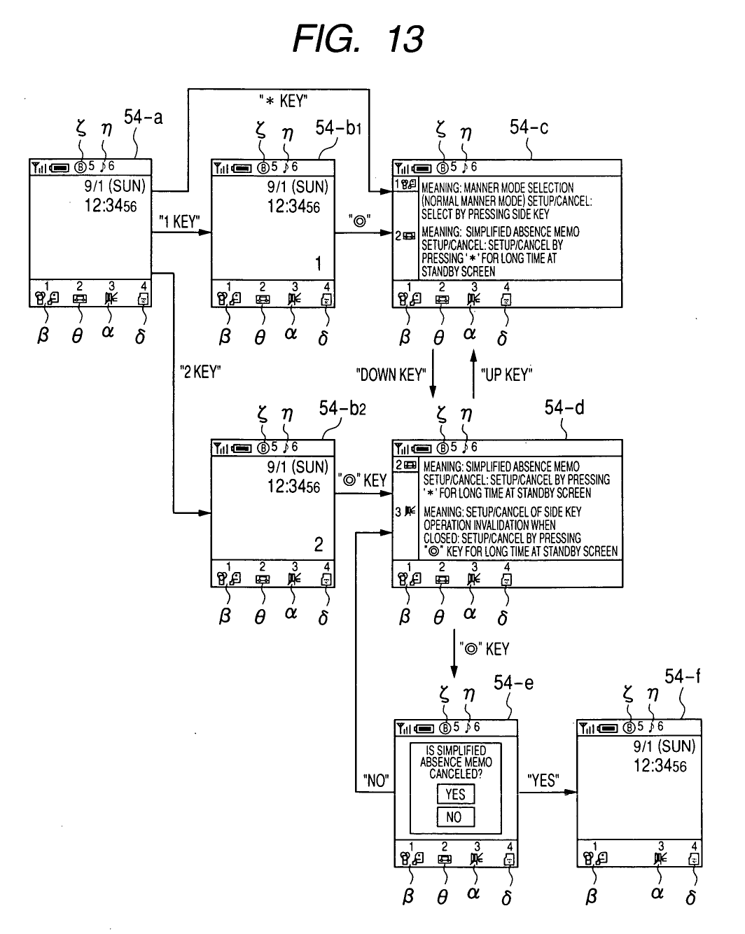

Referring to a flow chart of FIG. 12, a still further form of indication information display control processing in the digital mobile phone 2 of FIG. 3 will be described. Before the indication information display control processing is executed, a standby screen 54-a of FIG. 13 is displayed on the liquid crystal display 17. As a user manipulates the number keys of the manipulation keys 14, the indication information display control processing begins.

FIG. 13 shows the transition of a display screen displayed on the liquid crystal display 17 in the indication information display control processing of FIG. 12. On the standby screen 54-a, there are shown an icon α indicating that the side-key manipulation invalidating function is set, an icon β indicating that the manner mode is set to a typical manner mode, an icon δ indicating that the memory card 46 is mounted on the digital mobile phone 2 with a camera, an icon ζ indicating that a short range radio communication function (not shown) mounted on the digital mobile phone 2 is in a standby state, an icon η indicating that a music playing function (not shown) mounted on the digital mobile phone 2 is activated, and an icon θ indicating a simplified answering memo function operates at an incoming call. Further, numbers are displayed in the vicinities of the respective icons α to θ, and the number keys are previously associated with the displayed icons. Here, the icons α to θ serves as ‘indication information’, similar to the first to third embodiments.

In step S51, the manipulation input control section 33 of the main control section 31 judges whether the number key and the confirmation key of the manipulation keys 14 are pressed by a user. When it is judged that the number key of the manipulation keys 14 is pressed, the process proceeds to step S52. In the step S51, it may be judged whether the number key is pressed or not, it may be whether or not the confirmation key and the number key are pressed in an order of the confirmation key and the number key, or it may be judged whether or not the confirmation key and the number key are pressed in an order of the number key and the confirmation key.

When it is judged in the step S51 that the number key and the confirmation key of the manipulation keys 14 are pressed by a user (Yes of the step S51), the main control section 31 controls the LCD control section 36 such that the meaning of the icon associated with the pressed number key and the setting and releasing method are read so as to be displayed (step S52). Further, the icon associated with the pressed number key is brought into focus so as to be displayed.

For example, if the number key of ‘1’ is pressed is displayed in a state where a display screen 54-a of FIG. 13 is displayed, the display screen 54-a is transited to a display screen 54-b₁. In this state, if the confirmation key is further pressed, the display screen 54-b₁ is transited to a display screen 54-c such that the icon β (associated with the number key 1) is focused. Further, if the number key of ‘2’ is pressed in a state where the display screen 54-a of FIG. 13 is displayed, the display screen 54-a of FIG. 13 is transited to a display screen 54-b₂. In this state, if the confirmation key is further pressed, the display screen 54-b₂ is transited to a display screen 54-d such that the icon θ (associated with the number key 2) is brought into focus.

When it is judged in the step S51 that the number key and the confirmation key are not pressed, the main control section 31 judges that a predetermined key (for example, ‘*’ key, and hereinafter, the description will be made as ‘*’ key) of the manipulation keys 14 except for the number keys is pressed (step S53). Further, when it is judged that the ‘*’ key is not pressed, the process again proceeds to the step S51. When it is judged that the ‘*’ key is pressed, the process proceeds to step S54.

Next, if it is judged in the step S53 that the ‘*’ key is pressed, the main control section 31 reads the meaning of the indication information displayed on the standby screen and a list of setting and releasing methods from the memory section 47 in step S54. Further, the main control section 31 controls the LCD control section 36 such that the meaning and the list are displayed on the liquid crystal display 17. When the meaning of the indication information and the list of setting and releasing methods are displayed, the icon β associated with the number key ‘1’ is brought into focus so as to be displayed. In the case of FIG. 13, if the ‘*’ key is pressed in a state where the display screen 54-a is displayed, the display screen 54-a is transited into the display screen 54-c.

Further, the key which is pressed in the step S53 is not limited to the ‘*’ key, but may be another key. Further, it may be judged whether both of the ‘*’ key and the confirmation key are sequentially pressed or not, it may be judged whether the ‘*’ key and the confirmation key are simultaneously pressed or not, or it may be judged whether the ‘*’ key is pressed for a long period or not.

On the display screen 54-c of FIG. 13, the meaning of the icon β (corresponding to the number key 1) indicates that the manner mode is selected as a typical manner mode and the setting and releasing method thereof can be selected after the side key 16 is pressed. Further, the icon θ (corresponding to the number key 2) means a simplified answering memo function, and the setting and releasing method thereof can be performed by pressing a ‘#’ key for a long period on the standby key.

After the display processing in the step S52 or S54 is controlled by the main control section 31, the process proceeds to the step S55. Further, it is judged whether or not the selection of other setting information is accepted when the cross-shape key (upper or lower key) of the manipulation keys 14 is pressed by a user.

If it is judged in the step S55 that the selection of other setting information is accepted with the cross-shape key (upper or lower key) of the manipulation keys 14 being pressed by a user, the main control section 31 controls the LCD control section 36 such that the focus position of setting information displayed on the liquid crystal display 17 is moved in step S56. In accordance with the control of the LCD control section 36, the liquid crystal display 17 displays the moved focus position of setting information displayed on the liquid crystal display 17.

For example, if the cross-shape key (lower key) is pressed one time by a user, the setting information display screen 54-c of FIG. 13 is transited to the setting information display screen 54-d. Further, if the cross-shape key (upper key) of the manipulation keys 14 is pressed one time by a user, the setting information display screen 54-d is transited to the setting information display screen 54-c.

On the display screen 54-d of FIG. 13, the meaning of the icon θ (corresponding to the number key 2) indicates the setting of a short message memo and the setting and releasing method thereof can be performed by pressing the ‘#’ key for a long period on the standby screen. In addition, the meaning of the icon α (corresponding to the number key 3) indicates that the side key manipulation is invalided when the mobile phone 2 is closed and the setting and releasing method thereof can be performed by pressing the confirmation key (displayed by a double circle in FIG. 13) for a long period on the standby screen.

When it is judged in the step S55 that the selection of other setting information is not accepted with the cross-shape (upper or lower key) of the manipulation keys 14 being pressed by a user, the process proceeds to step S57.

In the step S57, the manipulation input control section 33 of the main control section 31 judges whether the confirmation key of the manipulation keys 14 is pressed by a user.

When it is judged in the step S57 that the confirmation key of the manipulation keys 14 is pressed by a user, the main control section 31 cancels or changes the function setting, based on the setting information of which the selection is accepted (step S58). After that, the main control section 31 stores data on the cancel or change of function setting into the memory section 47. In accordance with the control of the main control section 31, the memory section 47 stores the data on the cancel or change of function setting. Further, when it is judged that the confirmation key of the manipulation keys 14 is not pressed by a user, the process once again proceeds to the step S55.

For example, if the confirmation key of the manipulation keys 14 is pressed by a user in a state where the setting information display screen 54-d of FIG. 13 is displayed, the setting of the setting information which is brought into focus can be canceled or changed, as shown in the setting information display screen 54-e. For example, a selection screen on whether the simplified answering memo function is canceled or not is displayed, as shown in the setting information display screen 54-e. If a command of ‘yes’ is selected in such a state, the simplified answering memo function is canceled so that the setting information display screen 54-e returns to the setting information display screen 54-f.

On selection screen on whether the simplified answering memo function is canceled or not, if a command of ‘no’ is selected, the setting information display screen 54-e returns to the setting information display screen 54-d.

For example, even through a user unconsciously presses the ‘#’ key for a long period such that the short range radio communication function is set in a connection standby state, the battery can be prevented from being wasted when the user does not know the meaning of the indication information (icon) displayed on the standby screen.

In the fourth embodiment of the invention, the meaning of the indication information displayed on the standby screen can easily be noticed to a user. Further, as the indication information displayed on the standby screen is selected, the function setting (such as change or cancel) can be easily performed on the standby screen. Accordingly, the manipulation of the digital mobile phone with a camera can be enhanced, thereby enhancing the convenience of a user.

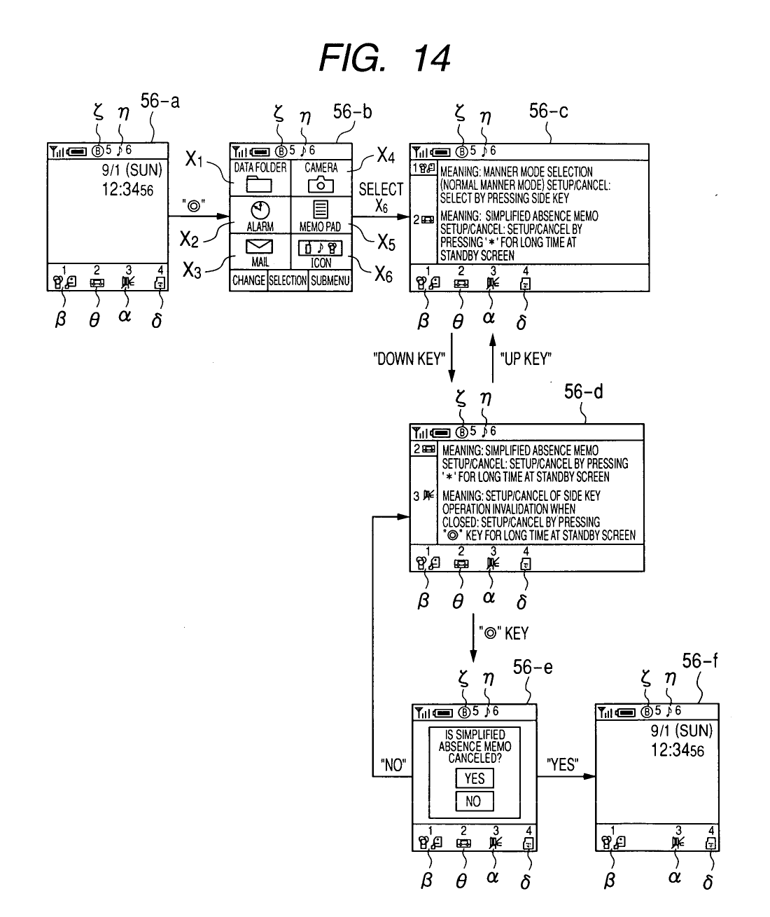

In the fourth embodiment of the invention, when the display screen is transited from the standby screen (the setting information display screen 54-a) to the display screen 54-c, the processing may be performed as shown in a transition screen of FIG. 14. In the case of FIG. 14, if the confirmation key is pressed on a standby screen 56-a, a function list screen 56-b is displayed so that six small function screens X1 to X6 are displayed. If the ‘icon’ selection screen X6 among them is selected, the function list screen 56-b is transited into a display screen 56-c of FIG. 14.

In the fourth embodiment of the invention, the display screen when the number key of ‘1’ and the confirmation key are sequentially pressed from the standby screen 54-a and the display screen when the ‘*’ key is pressed from the standby screen 54-a (including the display screen when the ‘*’ key and the confirmation key are pressed) are set to the same setting information display screen 54-c. Without being limited thereto, however, the display screen when the number key of ‘1’ and the confirmation key are sequentially pressed may be set so that the meaning of only the icon β (corresponding to the number key 1) and the setting and releasing method thereof are displayed.

According to the above-embodiments, the icon exemplified as an example of the indication information. Without being limited thereto, however, anything may be used which can indicate a function or function setting. Further, as for the icon of indication information, a two-dimensional or three-dimensional icon may be used.

The above-embodiments can be applied to PDAs (Personal Digital Assistant), personal computers, and other information processing devices, in addition to mobile phones.

The series of processing tasks described in these embodiments of the invention can be executed by a software or hardware.

According to the above-embodiments, it is shown that the steps of the flow chart are performed in a time-series manner along the described sequence. Without being performed in a time-series manner, however, the steps of the flow chart may be executed in parallel or individually.

According to the above-embodiments, the setting information on the setting of function indicated by indication information on a standby screen is displayed so as to be superimposed on the standby screen, and the selection of one piece of setting information among the plural pieces of setting information is accepted. Based on the setting information of which the selection is accepted, the function setting is canceled or changed. In accordance with the cancel or change of the function setting, the display of indication information is controlled.

According to the above-embodiments, the selection of one piece of indication information from plural pieces of indication information displayed on a standby screen is accepted, and the editing screen for editing a function indicated by the indication information, of which the selection is accepted, is displayed so as to be superimposed on the standby screen. Further, the indication of function editing from a user is accepted on the editing screen, so that the function editing is performed.

According to the above-embodiments, the meaning of indication information displayed on a standby screen can be easily noticed to a user. Further, as the indication information displayed on a standby screen is selected by a user, the function setting (for example, cancel or change) can be easily and directly performed on the standby screen.

### [FIG. 1A]

a. memo/clear
b. power
c. symbol
d. Sun.

### [FIG. 3]

a: TO RESPECTIVE SECTIONS

14: MANIPULATION KEY

20: CCD CAMERA

47: MEMORY SECTION

32: POWER SUPPLY CIRCUIT SECTION

31: MAIN CONTROL SECTION

33: MANIPULATION INPUT CONTROL SECTION

34: IMAGE ENCODER

35: CAMERA I/F SECTION

36: LCD CONTROL SECTION

37: IMAGE DECODER

38: MULTIPLE SEPARATION SECTION

45: RECORDING/REPRODUCING SECTION

39: MODULATION AND DEMODULATION CIRCUIT SECTION

40: VOICE CODEC

17: LIQUID CRYSTAL DISPLAY

21: SUB-DISPLAY

46: MEMORY CARD

43: TRANSMISSION AND RECEPTION CIRCUIT SECTION

15: MICROPHONE

18: SPEAKER

### [FIG. 4]

a: INDICATION INFORMATION DISPLAY CONTROL PROCESSING START

S1: IS LOWER KEY OF MANIPULATION KEYS PRESSED?

S2: DISPLAY REGION WHERE ONE PIECE OF INDICATION INFORMATION AMONG PLURAL PIECES OF INDICATION INFORMATION IS POSITIONED SUCH THAT REGION IS BROUGHT INTO FOCUS, AND DISPLAY SETTING INFORMATION ON SETTING OF FUNCTION INDICATED BY INDICATION INFORMATION SUCH THAT SETTING INFORMATION IS SUPERIMPOSED ON STANDBY SCREEN

S3: IS SELECTION OF OTHER INDICATION INFORMATION IS ACCEPTED WHEN LEFT OR RIGHT KEY OF MANIPULATION KEYS IS PRESSED?

S4: IS SELECTION OF OTHER SETTING INFORMATION IS ACCEPTED WHEN UPPER OR LOWER KEY OF MANIPULATION KEYS IS PRESSED?

S5: MOVE FOCUS POSITION OF DISPLAYED SETTING INFORMATION

S6: IS CONFIRMATION KEY OF MANIPULATION KEYS PRESSED?

S7: BASED ON SETTING INFORMATION OF WHICH SELECTION IS ACCEPTED, CANCEL OR CHANGE FUNCTION SETTING

S8: CONTROL DISPLAY OF INDICATION INFORMATION

b: END

### [FIG. 5]

a. Sun
b. LOWER KEY
c: SIDE KEY MANIPULATION HAS BEEN INVALIDATED. WOULD YOU VALIDATE?
d: TYPICAL MANNER MODE
e: DRIVE MODE
f: ORIGINAL MODE
g: MANNER MODE CANCEL

### [FIG. 6]

a: INDICATION INFORMATION DISPLAY CONTROL PROCESSING START

S11: IS LOWER KEY OF MANIPULATION KEYS PRESSED?

S12: DISPLAY REGION WHERE ONE PIECE OF INDICATION INFORMATION AMONG PLURAL PIECES OF INDICATION INFORMATION IS POSITIONED SUCH THAT REGION IS BROUGHT INTO FOCUS

S13: IS SELECTION OF OTHER INDICATION INFORMATION IS ACCEPTED WHEN LEFT OR RIGHT KEY OF MANIPULATION KEYS IS PRESSED?

S14: IS CONFIRMATION KEY OF MANIPULATION KEYS PRESSED?

S15: DISPLAY SETTING INFORMATION ON SETTING OF FUNCTION INDICATED BY INDICATION INFORMATION SUCH THAT SETTING INFORMATION IS SUPERIMPOSED ON STANDBY SCREEN

S16: IS SELECTION OF OTHER SETTING INFORMATION IS ACCEPTED WHEN UPPER OR LOWER KEY OF MANIPULATION KEYS IS PRESSED?

S17: MOVE FOCUS POSITION OF DISPLAYED SETTING INFORMATION

S18: IS CONFIRMATION KEY OF MANIPULATION KEYS PRESSED?

S19: BASED ON SETTING INFORMATION OF WHICH SELECTION IS ACCEPTED, CANCEL OR CHANGE FUNCTION SETTING

S20: CONTROL DISPLAY OF INDICATION INFORMATION

S21: IS ‘RETURN’ BUTTON OF MANIPULATION KEYS PRESSED?

b: END

### [FIG. 7]

a: Sun.

b: LOWER KEY

c: SIDE KEY MANIPULATION HAS BEEN INVALIDATED. WOULD YOU VALIDATE?

d: LEFT KEY

e: RIGHT KEY

f: TYPICAL MANNER MODE

g: DRIVE MODE

h: ORIGINAL MODE

i: MANNER MODE CANCEL

### [FIG. 8]

a: INDICATION INFORMATION DISPLAY CONTROL PROCESSING START

S31: IS LOWER KEY OF MANIPULATION KEYS PRESSED?

S32: DISPLAY REGION WHERE ONE PIECE OF INDICATION INFORMATION AMONG PLURAL PIECES OF INDICATION INFORMATION IS POSITIONED SUCH THAT REGION IS ENLARGED AND BROUGHT INTO FOCUS

S33: IS SELECTION OF OTHER INDICATION INFORMATION IS ACCEPTED WHEN LEFT OR RIGHT KEY OF MANIPULATION KEYS IS PRESSED?

S34: IS CONFIRMATION KEY OF MANIPULATION KEYS PRESSED?

S35: DISPLAY EDITING SCREEN FOR EDITING FUNCTION INDICATED BY INDICATION INFORMATION SUCH THAT EDITING SCREEN IS SUPERIMPOSED ON STANDBY SCREEN

S36: IS SELECTION OF PORTION TO BE EDITED ON EDITING SCREEN ACCEPTED WHEN MANIPULATION KEY IS PRESSED?

S37: MOVE FOCUS POSITION OF PORTION TO BE EDITED ON DISPLAYED EDITING SCREEN

S38: IS INDICATION OF FUNCTION EDITING ACCEPTED?

S39: IS CONFIRMATION KEY OF MANIPULATION KEYS PRESSED?

S40: EDIT FUNCTION

S41: IS ‘RETURN’ BUTTON OF MANIPULATION KEYS PRESSED?

b: END

### [FIG. 9]

a: LEFT KEY
b: LOWER KEY

### [FIG. 11]

a: AFTER MEETING WITH MR. TANAKA . . .

### [FIG. 12]

a: INDICATION INFORMATION DISPLAY CONTROL PROCESSING START

S51: IS NUMBER KEY AND CONFIRMATION KEY OF MANIPULATION KEYS PRESSED?

S52: DISPLAY MEANING AND RELEASING METHOD OF INDICATION INFORMATION CORRESPONDING TO PRESSED NUMBER KEY SUCH THAT MEANING AND RELEASING METHOD ARE BROUGHT INTO FOCUS

S53: IS ‘*’ KEY OF MANIPULATION KEYS PRESSED?

S54: READ AND DISPLAY MEANING AND RELEASING METHOD OF INDICATION INFORMATION WHICH IS CURRENTLY DISPLAYED ON STANDBY SCREEN

S55: IS UPPER OR LOWER KEY OF MANIPULATION KEYS PRESSED?

S56: MOVE FOCUS POSITION OF DISPLAYED SETTING INFORMATION

S57: IS CONFIRMATION KEY OF MANIPULATION KEYS PRESSED?

S58: BASED ON SETTING INFORMATION OF WHICH SELECTION IS ACCEPTED, CANCEL OR CHANGE FUNCTION SETTING

b: END

### [FIG. 13]

a: ‘*’ KEY

b: ‘1’ KEY

c: ‘2’ KEY

d. MEANING: MANNER MODE SELECTION (NORMAL MANNER MODE) SETUP/CANCEL: SELECT BY PRESSING SIDE KEY

e. MEANING: SIMPLIFIED ABSENCE MEMO SETUP/CANCEL: SETUP/CANCEL BY PRESSING ‘*’ FOR LONG TIME AT STANDBY SCREEN

f. ‘DOWN KEY’

g. ‘UP KEY’

h. MEANING: SIMPLIFIED ABSENCE MEMO SETUP/CANCEL: SETUP/CANCEL BY PRESSING ‘*’ FOR LONG TIME AT STANDBY SCREEN

i. MEANING: SETUP/CANCEL OF SIDE KEY OPERATION INVALIDATION WHEN CLOSED: SETUP/CANCEL BY PRESSING ‘’ KEY FOR LONG TIME AT STANDBY SCREEN

j. ‘’ KEY

k. IS SIMPLIFIED ABSENCE MEMO CANCELED?

l. Sun

### [FIG. 14]

X₁: DATA FOLDER

X₂: CAMERA

X₃: ALARM

X₄: MEMO PAD

X₅: MAIL

X₆: ICON

a. CHANGE

b. SELECTION

c. SUBMENU

d. SELECT X₆

e. MEANING: MANNER MODE SELECTION (NORMAL MANNER MODE) SETUP/CANCEL: SELECT BY PRESSING SIDE KEY

f. MEANING: SIMPLIFIED ABSENCE MEMO SETUP/CANCEL: SETUP/CANCEL BY PRESSING ‘*’ FOR LONG TIME AT STANDBY SCREEN

g. ‘DOWN KEY’

h. ‘UP KEY’

i. MEANING: SIMPLIFIED ABSENCE MEMO SETUP/CANCEL: SETUP/CANCEL BY PRESSING ‘*’ FOR LONG TIME AT STANDBY SCREEN

j. MEANING: SETUP/CANCEL OF SIDE KEY OPERATION INVALIDATION WHEN CLOSED: SETUP/CANCEL BY PRESSING ‘’ KEY FOR LONG TIME AT STANDBY SCREEN

k. ‘’ KEY

l. IS SIMPLIFIED ABSENCE MEMO CANCELED?

What is claimed is:

1. An information processing device comprising:
a display unit configured to display a plurality of setting informations of a setting of function indicated by indication information displayed on a standby screen;
a key unit configured to accept a selection of one piece of setting information among the plurality of setting informations;
a control unit configured to cancel or change function setting, based on the setting information of which the selection is accepted by the key unit; and
a display control unit configured to control a display of the indication information, which is performed by the display unit, in accordance with the cancel or the change of function setting performed by the control unit.

2. The information processing device according to claim 1, wherein the indication information is an icon.

3. The information processing device according to claim 1, wherein the plurality of setting informations of the setting of function comprises a plurality of modes,
wherein, if a mode of the plurality of modes is canceled by the control unit, the display control unit performs control in accordance with the cancel of the mode by the control unit such that the indication information, which is currently displayed by the display unit, is not displayed.

4. The information processing device according to claim 1, wherein the plurality of setting informations of the setting of function comprises a plurality of modes,
wherein, if a mode of the plurality of modes is changed by the control unit, the control unit performs control in accordance with the change of the mode performed by the control unit such that the indication information, which is currently displayed by the display unit, is changed into the indication information indicating the changed function setting so as to be displayed.

5. The information processing device according to claim 1, wherein an antenna pictogram indicating a current sensitivity level of an antenna is displayed on the standby screen.

6. The information processing device according to claim 1, wherein the key unit is configured to accept a selection of one piece of indication information among at least one piece of indication informations displayed on the standby screen, and
the display unit displays to superimpose the plurality of setting informations of the setting of function indicated by indication information on the standby screen in accordance with the one piece of indication information, of which the selection is accepted by the key unit.

7. The information processing device according to claim 1, wherein, when the function setting is canceled by the control unit, the control unit performs control in accordance with the cancel of function setting performed by the control unit such that the indication information, which is currently displayed by the display unit, is not displayed.

8. The information processing device according to claim 1, wherein, if the function setting is changed by the control unit, the control unit performs control in accordance with the change of function setting performed by the control unit such that the indication information, which is currently displayed by the display unit, is changed into the indication information indicating the changed function setting so as to be displayed.

9. The information processing device according to claim 1, further comprising:
a setting unit configured to set a function based on the one piece of setting information of which the selection is accepted by the key unit in case that the setting of function indicated by indication information displayed on the standby screen is canceled,
wherein, in accordance with the function set by the key unit, the control unit controls the display of the indication information, which is performed by the display unit.

10. An information processing device comprising:
an key unit configured to accept a selection of one piece of indication information among a plurality of indication informations displayed on a standby screen;
a display unit configured to display an editing screen for editing a function indicated by the one piece of indication information, of which the selection is accepted by the key unit; and
an editing unit configured to edit the function by accepting an indication of function editing.

11. The information processing device according to claim 10, wherein the plurality of indication informations are icons.

12. The information processing device according to claim 10, wherein an antenna pictogram indicating a current sensitivity level of an antenna is displayed on the standby screen.

13. The information processing device according to claim 10, wherein, after gradually enlarging and displaying the one piece of indication information of which the selection is accepted by the key unit, the display unit displays to superimpose the editing screen on the standby screen.

14. A mobile phone comprising:
a display unit configured to display a plurality of setting informations of a setting of function indicated by indication information displayed on a standby screen;
a key unit configured to accept a selection of one piece of setting information among the plurality of setting informations;
a control unit configured to cancel or change function setting, based on the setting information, the setting information of the selection being accepted by the key unit; and
a display control unit configured to control a display of the indication information in accordance with the cancel or the change of function setting performed by the control unit.

15. The information processing device according to claim 14, wherein an antenna pictogram indicating a current sensitivity level of an antenna is displayed on the standby screen.
